(19) United States
(12) Patent Application Publication
(10) Pub. No.: US 2024/0143987 A1
(43) Pub. Date: May 2, 2024

(54) INTEGRATED CIRCUIT CONFIGURED TO EXECUTE AN ARTIFICIAL NEURAL NETWORK

(71) Applicants: STMicroelectronics FRANCE, Montrouge (FR); STMicroelectronics (Grenoble 2) SAS, Grenoble (FR)

(72) Inventors: Vincent HEINRICH, Izeaux (FR); Pascal URARD, Theys (FR); Bruno PAILLE, Engins (FR)

(21) Appl. No.: 18/382,638

(22) Filed: Oct. 23, 2023

(30) Foreign Application Priority Data
Oct. 28, 2022 (FR) 2211288

(51) Int. Cl. G06N 3/063

(52) U.S. Cl. CPC G06N 3/063

(57) ABSTRACT

An integrated circuit includes a computer unit configured to execute the neural network. Parameters of the neural network are stored in a first memory. Data supplied at the input of the neural network or generated by the neural network are stored in a second memory. A first barrel shifter circuit transmits data from the second memory to the computer unit. A second barrel shifter circuit delivers data generated during the execution of the neural network by the computer unit to the second memory. A control unit is configured to control the computer unit, the first and second barrel shifter circuits, and accesses to the first memory and to the second memory.

### PRIORITY CLAIM

This application claims the priority benefit of French Application for Patent No. 2211288, filed on Oct. 28, 2022, the content of which is hereby incorporated by reference in its entirety to the maximum extent allowable by law.

### TECHNICAL FIELD

Embodiments and implementations relate to artificial neural networks.

### BACKGROUND

Artificial neural networks are used to carry out data functions when they are executed. For example, a function of a neural network may be a classification. Another function may consist in generating a signal from a signal received at the input.

Artificial neural networks generally comprise a series of neural layers.

Each layer receives input data to which weights are applied and the layer then outputs output data after processing by activation functions of the neurons of said layer. This output data is sent to the next layer in the neural network. The weights are parameters that are configurable to obtain good output data.

For example, neural networks may be implemented by final hardware platforms, such as microcontrollers integrated in connected objects or in specific dedicated circuits.

In general, neural networks are trained during a learning phase before being integrated into the final hardware platform. The learning phase may be supervised or not. The learning phase allows for adjustment to be made to the weights of the neural network to obtain good output data of the neural network. For this purpose, the neural network may be executed by taking as input already classified data of a reference database. The weights are adapted as a function of the data obtained at the output of the neural network compared to expected data.

The execution of a neural network driven by an integrated circuit requires handling of a large amount of data.

This handling of the data may result in considerable energy consumption, in particular when the integrated circuit should perform many memory accesses in writing or in reading.

Hence, these integrated circuits used to implement neural networks are generally energy-intensive and have a complex and bulky structure. Furthermore, these integrated circuits are barely flexible in terms of parallelization of the execution of the neural network.

Hence, there is a need to provide an integrated circuit allowing executing a neural network rapidly while reducing the energy consumption thereof necessary to execute an artificial neural network. There is also a need to provide such an integrated circuit which has a simple structure so as to reduce its dimensions.

### SUMMARY

According to one aspect, an integrated circuit is provided including: a first memory configured to store parameters of a neural network to be executed; a second memory configured to store data supplied at the input of the neural network to be executed or generated by the neural network; a computer unit configured to execute the neural network; a first barrel shifter circuit between an output of the second memory and the computer unit, the first barrel shifter circuit being configured to transmit the data from the output of the second memory to the computer unit; a second barrel shifter circuit between the computer unit and the second memory, the second barrel shifter circuit being configured to deliver the data generated during the execution of the neural network by the computer unit; and a control unit configured to control the computer unit and the first and second barrel shifter circuits.

Such an integrated circuit has the advantage of integrating memories for the storage of the parameters of the neural network (these parameters including the weights of the neural network but also its topology, i.e., the number and the type of layers), input data of the neural network and data generated at the output of the different layers of the neural network. Thus, the memories can be accessed directly by the computer unit of the integrated circuit, and are not shared through a bus. Hence, such an integrated circuit allows for reducing the displacement of the parameters of the first memory and the data of the second memory. This allows for making the execution of the artificial neural network more rapid.

The use of a memory to store the parameters of the neural network allows adaptability of the circuit to the task to be carried out (the weights as well as the topology of the neural network being programmable).

Furthermore, the use of barrel shifter circuits enables an energy-efficient handling of the data. In particular, the first barrel shifter circuit allows for simply reading the data stored in the second memory when these data are necessary for the execution of the neural network by the computer unit. The second barrel shifter circuit allows for simply writing in the second memory the data generated by the computer unit during the execution of the neural network. The barrel shifter circuits are sized so that, for the execution of the neural network, useful data could be written in these circuits on data, as soon as these last data are no longer useful for the execution of the neural network.

The data and the weights being placed in the memories of the integrated circuit can be accessed at each clock pulse of the integrated circuit.

Such an integrated circuit has a simple, compact and energy-efficient structure, in particular thanks to the use of barrel shifter circuits instead of using a crossbar interconnection circuit (also known as “crossbar”).

In an advantageous embodiment, the computer unit comprises a bank of processing elements configured to parallelize the execution of the neural network, the first barrel shifter circuit being configured to transmit the data from the second memory to the different processing elements.

Such an integrated circuit enables a parallelization of the operations during the execution of the neural network.

Preferably, the integrated circuit further includes a first multiplexer stage, the first barrel shifter circuit being connected to the second memory via the first multiplexer stage, the first multiplexer stage being configured to deliver to the first barrel shifter circuit a data vector from the data stored in the second memory, the first barrel shifter circuit being configured to shift the data vector of the first multiplexer stage.

Preferably, the integrated circuit further includes a second multiplexer stage, the computer unit being connected to the first barrel shifter circuit via the second multiplexer stage, the second multiplexer stage being configured to deliver the data vector shifted by the first barrel shifter circuit to the computer unit.

In an advantageous embodiment, the integrated circuit further includes a buffer memory, the second barrel shifter circuit being connected to the computer unit via the buffer memory, the buffer memory being configured to temporarily store the data generated by the computer unit during the execution of the neural network before the second barrel shifter circuit delivers these data to the second memory. For example, this buffer memory may consist of a hardware memory or of a temporary storage element (flip-flop).

Preferably, the integrated circuit further includes a pruning stage between the buffer memory and the second barrel shifter circuit, the pruning stage being configured to delete data, in particular useless data, among the data generated by the computer unit.

Advantageously, the second memory is configured to store data matrices supplied at the input of the neural network to be executed or generated by this neural network, each data matrix may have several data channels, the data of each data matrix being grouped together in the second memory in at least one data group, the data groups being stored in different banks of the second memory, the data of each data group being intended to be processed in parallel by the different processing elements of the computer unit.

For example, the data matrices may be images received at the input of the neural network. The position of the data then corresponds to pixels of the image. The data matrices may also correspond to a characteristic map generated by the execution of a layer of the neural network by the computer unit (also known as “feature map” and “activation map”).

The placement of the data and of the parameters of the neural network in the first memory and the second memory of the integrated circuit enables access to the data necessary for the execution of the neural network at each clock pulse of the integrated circuit.

In an advantageous embodiment, each data group of a data matrix includes data of at least one position of the data matrix for at least one channel of the data matrix.

Thus, such an integrated circuit is suited to parallelize the execution of the neural network in width (over the different positions of the data in the data matrix) and in depth (over the different channels of the data matrices). In particular, the computer unit may comprise a bank of processing elements configured to parallelize the execution of the neural network in width and in depth.

According to another aspect, a system-on-chip is provided including an integrated circuit as described before.

Such a system-on-chip has the advantage of being able to execute an artificial neural network by using the integrated circuit alone. Hence, such a system-on-chip does not require any interventions of a microcontroller of the system-on-chip for the execution of the neural network. Nor does such a system-on-chip require the use of a common bus of the system-on-chip for the execution of the neural network. Thus, the artificial neural network may be executed more rapidly, more simply while reducing the energy consumption required for the execution thereof.

### BRIEF DESCRIPTION OF THE DRAWINGS

Further advantages and features of the invention will become apparent on studying the detailed description of embodiments, which are in no way restrictive, and the appended drawings wherein:

FIG. 1 illustrates an embodiment of a system-on-chip;

FIG. 2 illustrates an embodiment of the integrated circuit for the implementation of neural networks; and

FIG. 3 illustrates an embodiment of an arrangement of a memory.

### DETAILED DESCRIPTION

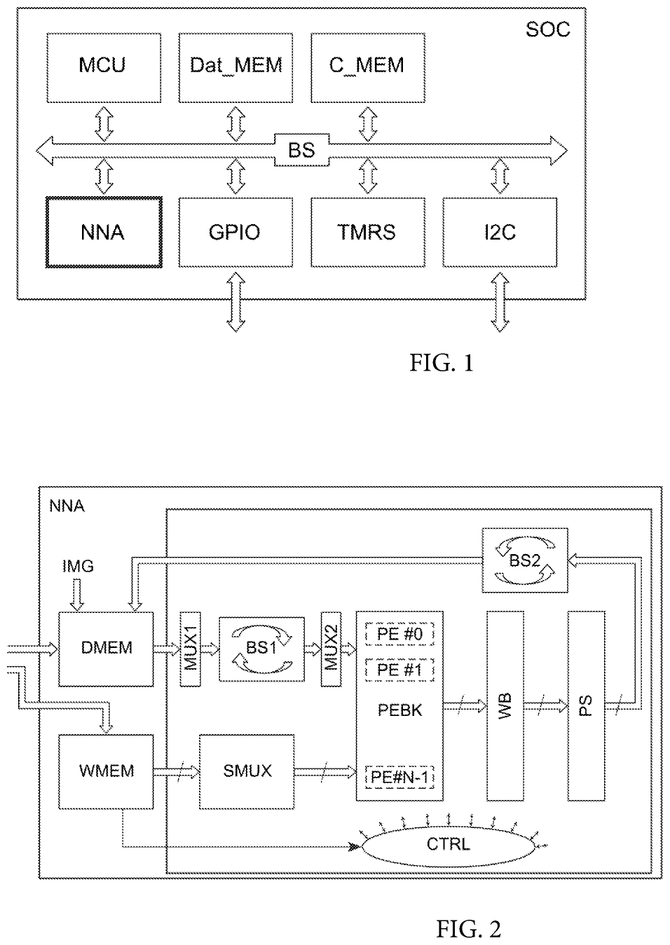

FIG. 1 illustrates an embodiment of a system-on-chip SOC. The system-on-chip conventionally includes a microcontroller MCU, a data memory Dat MEM, at least one code memory C MEM, a time measuring circuit TMRS (“timer”), general-purpose input-output ports GPIO, and a communication port I2C.

The system-on-chip SOC also includes an integrated circuit NNA for the implementation of artificial neural networks. Such an integrated circuit NNA may also be referred to as “neural network acceleration circuit”.

The system-on-chip SOC also comprises buses allowing interconnecting the different elements of the system-on-chip SOC.

FIG. 2 illustrates an embodiment of the integrated circuit NNA for the implementation of neural networks.

This integrated circuit NNA includes a computer unit PEBK. The computer unit PEBK includes a bank of at least one processing element PE. Preferably, the computer unit PEBK includes several processing elements PE #0, PE #1, . . . , PE #N−1 in the bank. Each processing element PE is configured to perform elementary operations for the execution of the neural network. For example, each processing element PE is configured to perform convolution, pooling, scaling elementary operations, of activation functions of the neural network.

The integrated circuit NNA further includes a first memory WMEM configured to store parameters of the neural network to be executed, in particular weights and a configuration of the neural network (in particular its topology). The first memory WMEM is configured to receive the parameters of the neural network to be executed before the implementation of the neural network from the data memory Dat MEM of the system-on-chip. The first memory WMEM may be a volatile memory.

The integrated circuit further includes a shift stage SMUX having inputs connected to the outputs of the first memory WMEM. Thus, the shift stage SMUX is configured to receive the parameters of the neural network to be executed stored in the first memory WMEM. The shift stage SMUX also includes outputs connected to inputs of the computer unit PEBK. In this manner, the computer unit PEBK is configured to receive the parameters of the neural network so as to be able to execute it. In particular, the shift stage SMUX is configured to select the weights and configurations data in the memory to deliver them to the computer unit PEBK, and more particularly to the different processing elements PE.

The integrated circuit NNA also includes a second memory DMEM configured to store data supplied to the neural network to be executed or generated during execution thereof by the computer unit PEBK. Thus, for example, the data may be input data of the neural network or data (also referred to as “activation”) generated at the output of the different layers of the neural network. The second memory DMEM may be a volatile memory.

The integrated circuit NNA further includes a first multiplexer stage MUX1. The first multiplexer stage MUX1 includes inputs connected to the second memory DMEM. The first multiplexer stage MUX1 is configured to deliver a data vector from the data stored in the second memory DMEM.

The integrated circuit NNA further includes a first barrel shifter circuit BS1 (also known as “barrel shifter”). The first barrel shifter circuit BS1 has inputs connected to the outputs of the first multiplexer stage MUX1. Thus, the first barrel shifter circuit MUX1 is configured so as to be able to receive the data transmitted by the first multiplexer stage MUX1. The first barrel shifter circuit BS1 is configured to shift the data vector of the first multiplexer stage MUX1. The first barrel shifter circuit MUX1 has outputs configured to deliver the data of this first barrel shifter circuit BS1.

The integrated circuit NNA also includes a second multiplexer stage MUX2. This second multiplexer stage MUX2 has inputs connected to the outputs of the first barrel shifter circuit BS1. The second multiplexer stage MUX2 also includes outputs connected to inputs of the computer unit PEBK. Thus, the computer unit PEBK is configured to receive the data of the first barrel shifter circuit BS1. The second multiplexer stage MUX2 is configured to deliver the data vector shifted by the first barrel shifter circuit B Si to the computer unit PEBK, so as to transmit the data of the data vector to the different processing elements PE.

The integrated circuit NNA further includes a buffer memory WB (“buffer”) at the output of the computer unit PEBK. Hence, the buffer memory WB includes inputs connected to an output of the computer unit PEBK. Thus, the buffer memory WB is configured to receive the data computed by the computer unit PEBK. In particular, the buffer memory WB may be a storage element allowing storing one single data word.

The integrated circuit NNA also includes a pruning stage PS. The pruning stage PS includes inputs connected to outputs of the buffer memory WB. This pruning stage PS is configured to delete the useless data delivered by the computer unit PEBK. The pruning stage WB being configured to delete some useless data generated by the computer unit PEBK. In particular, data generated by the computer unit PEBK are useless when the execution of the neural network has a stride greater than one.

The integrated circuit NNA also includes a second barrel shifter circuit BS2. The second barrel shifter circuit BS2 has inputs connected to outputs of the pruning stage PS. The second barrel shifter circuit BS2 has outputs connected to inputs of the second memory DMEM. The second barrel shifter circuit BS2 is configured to shift the data vector delivered by the pruning stage PS before storing them in the second memory DMEM.

The integrated circuit NNA further includes a control unit CTRL configured to control the different elements of the integrated circuit NNA, i.e., the shift stage SMUX, the first multiplexer stage MUX1, the first barrel shifter circuit BS1, the second multiplexer stage MUX2, the computer unit PEBK, the buffer memory WB, the pruning stage PS, the second barrel shifter circuit BS2 as well as the accesses to the first memory WMEM and to the second memory DMEM. In particular, the control unit CTRL does not access the useful data of the first memory WMEM and of the second memory DMEM.

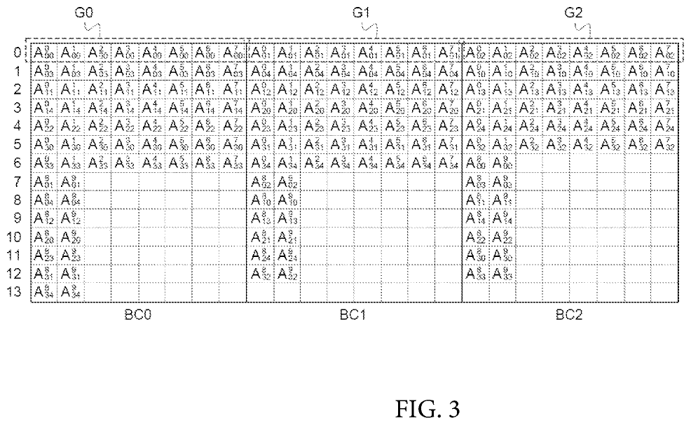

FIG. 3 illustrates an embodiment of an arrangement of the second memory DMEM. The memory DMEM includes several data banks. The memory DMEM herein includes three data banks. The number of banks is greater than or equal to a parallelization capacity in width by the processing elements of the computer unit (i.e., a parallelization over a number of positions of the same channel of a data matrix). Each bank is represented in the table having a predefined number of rows and columns. The memory is herein configured to record data of a data matrix, for example an image or a characteristic map, having several channels. The data of the matrix are stored in the different banks of the memory DMEM. The data matrix herein has four rows, five columns and ten channels. Each piece of data of the matrix has a value A_{xy}^{c}, where c ranges from 0 to 9 and indicates the channel of this piece of data of the matrix, x and y indicate the position of the piece of data in the matrix, x ranging from 0 to 3 and corresponding to the row of the matrix, and y ranging from 0 to 4 and corresponding to the column of the matrix.

The data of the matrix are stored in groups in the different banks of the memory DMEM. In particular, each data group of a data matrix includes data of at least one position of the data matrix and of at least one channel of the data matrix. The maximum number of data of each group is defined according to a parallelization capacity in depth (i.e., a parallelization over a given number of channels of the matrix) of the execution of the neural network by the computer unit.

The number of processing elements PEKB corresponds to a maximum parallelization for the execution of the neural network, i.e., a parallelization in width multiplied by a parallelization over the different channels of the data. Thus, the number of processing elements PE may be equal to the number of banks of the memory DMEM multiplied by the number of channels of each bank of the memory DMEM. In general, this maximum parallelization is not used all the time during the execution of a neural network, in particular because of the reduction of the dimensions of the layers in the depth of the neural network.

The groups are formed according to the parallelization capacity of the computer unit in width and in depth. For example, the group G0 comprises the data A₀₀⁰ to A₀₀⁷ in the bank BC0, the group G1 comprises the data A₀₁⁰ to A₀₂⁰ A₀₁⁹ in the bank BC1, the group G2 comprises the data A₀₂⁰ to A₀₂⁹ in the bank BC2.

More particularly, the data of the different channels of the matrix having the same position in the matrix are stored on the same row of the same bank. If the number of channels is greater than the number of columns of a bank, then it is not possible to store on the same row of a bank, and therefore in the same group, all of the data of the different channels having the same position in the matrix. The remaining data are then stored in free rows at the end of each bank. For example, the data A₀₀⁰ to A₀₀⁷ of the group G0 are stored on the row #0 of the bank BC0, and the data A₀₀⁸ and A₀₀⁹ are stored in the row #6 of the bank BC2.

The first barrel shifter circuit has a number of inputs equal to the number of banks of the memory DMEM and the second barrel shifter circuit has a number of outputs equal to the number of banks of the memory DMEM. In this manner, the first barrel shifter circuit is configured to receive the data of the different banks.

The use of barrel shifter circuits BS1 and BS2 allows for an energy-efficient handling of the data. Indeed, the first barrel shifter circuit allows simply reading the data stored in the second memory when these data are necessary for the execution of the neural network by the computer unit. In turn, the second barrel shifter circuit allows simply writing in the second memory the data generated by the computer unit during the execution of the neural network. The barrel shifter circuits are sized so that, for the execution of the neural network, useful data could be written in these circuits on data, as soon as these last data are no longer useful for the execution of the neural network.

Hence, such an arrangement of the data of the matrix in the memory allows simplifying handling of the data using the first barrel shifter circuit and the second barrel shifter circuit. Furthermore, such an arrangement of the data of the matrix in the memory enables a simple access to the memory DMEM in reading and in writing.

1. An integrated circuit, including:
a computer unit configured for executing a neural network;
a first memory configured to store parameters of the neural network to be executed;
a second memory configured to store data supplied at an input of the computer unit to be executed or generated by the neural network;
a first barrel shifter circuit between an output of the second memory and the input of the computer unit, the first barrel shifter circuit being configured to transmit the data from the output of the second memory to computer unit;
a second barrel shifter circuit between an output of the computer unit and the second memory, the second barrel shifter circuit being configured to deliver data generated during the execution of the neural network; and
a control unit configured to control the computer unit, the first and second barrel shifter circuits as well as the accesses to the first memory and to the second memory.

2. The integrated circuit according to one of claim 1, wherein the computer unit comprises a bank of processing elements configured to parallelize execution of the neural network, and wherein the first barrel shifter circuit is configured to transmit the data from the second memory to the different processing elements.

3. The integrated circuit according to claim 1, further including a first multiplexer stage, wherein an input of the first barrel shifter circuit is connected to the second memory via the first multiplexer stage, and wherein the first multiplexer stage is configured to deliver to the first barrel shifter circuit a data vector from the data stored in the second memory, the first barrel shifter circuit being configured to shift the data vector of the first multiplexer stage.

4. The integrated circuit according to claim 3, further including a second multiplexer stage, wherein the input of the computer unit is connected to the first barrel shifter circuit via the second multiplexer stage, and wherein the second multiplexer stage is configured to deliver the data vector shifted by the first barrel shifter circuit to the computer unit.

5. The integrated circuit according to claim 1, further including a buffer memory, wherein the second barrel shifter circuit is connected to the computer unit via the buffer memory, and wherein the buffer memory is configured to temporarily store the data generated by the computer unit during the execution of the neural network before the second barrel shifter circuit delivers the data to the second memory.

6. The integrated circuit according to claim 5, further including a pruning stage between the buffer memory and the second barrel shifter circuit, wherein the pruning stage is configured to delete some data among the data generated by the computer unit.

7. The integrated circuit according to claim 1, wherein the second memory is configured to store data matrices supplied at the input of the computer unit to be executed or generated by the computer unit, wherein each data matrix has several data channels, the data of each data matrix being grouped together in the second memory in at least one data group, the data groups being stored in different banks of the second memory, the data of each data group configured for processing in parallel by the different processing elements of the computer unit.

8. The integrated circuit according to claim 7, wherein each data group of a data matrix includes data of at least one position of the data matrix for at least one channel of the data matrix.

9. A system-on-chip including an integrated circuit according to claim 1.

10. An integrated circuit, comprising:
a computer unit having a first input, a second input and an output;
a first memory configured to store first data;
a second memory configure to store second data applied to the second input of the computer unit;
a first barrel shifter unit having an input configured to receive first data from the first memory and an output configured to deliver barrel shifted first data to the first input of the computer unit;
a second barrel shifter unit having an input configured to receive output data from the output of the computer unit and an output configured to deliver barrel shifted output data for storage in the first memory; and
a control circuit configured to control execution operation by the computer unit, barrel shifting operation by the first and second barrel shifter unit and read/write operation of the first and second memories.

11. The integrated circuit of claim 10, wherein the first data comprises input data for neural network process executed by the computer network and the second data comprises parameter data for configuring the neural network process.

12. The integrated circuit of claim 10, further comprising a pruning circuit coupled between the output of the computer unit and the input of the second barrel shifter unit, said pruning circuit configured to prune useless data from the output data.

13. The integrated circuit of claim 10, further comprising a buffer circuit coupled between the output of the computer unit and the input of the second barrel shifter unit, said buffer circuit configured to buffer store the output data.

14. The integrated circuit of claim 10, wherein the computer unit comprises a plurality of processing units executing in parallel.

15. The integrated circuit of claim 14, further comprising a shift circuit configured to shift second data from the second memory for application to ones of the processing units.

16. The integrated circuit of claim 10, wherein the first data comprises a first data vector, and further comprising:
a first multiplexing circuit having an input configured to receive the first data vector and an output coupled to the input of the first barrel shifter unit and configured to generate a shifted data vector for input to the first barrel shifter unit; and
a second multiplexing circuit having an input coupled to the output of the first barrel shifter unit and an output configured to generate a second data vector for input to the computer unit.

17. The integrated circuit of claim 16, wherein the computer unit comprises a plurality of processing units executing in parallel and configured to receive the second data vector.
